(19) United States
(12) Patent Application Publication
(10) Pub. No.: US 2018/0210467 A1
(43) Pub. Date: Jul. 26, 2018

(54) UNMANNED AERIAL VEHICLE AND METHOD OF USING A PLURALITY OF UNMANNED AERIAL VEHICLES TO SHOW A FEELING EFFECT

(71) Applicant: Chan-Shin WU, Taipei City (TW)

(72) Inventor: Chan-Shin WU, Taipei City (TW)

(21) Appl. No.: 15/868,118

(22) Filed: Jan. 11, 2018

(30) Foreign Application Priority Data
Jan. 20, 2017 (TW) 106102073

(51) Int. Cl. G05D 1/10; G05D 1/00; B64D 47/02; G08G 5/00; G08G 5/04; B64C 39/02

(52) U.S. Cl. CPC G05D 1/104; G05D 1/0027; B64D 47/02; B64C 2201/146; G08G 5/04; B64C 39/024; B64C 2201/12; G08G 5/0034

(57) ABSTRACT

An unmanned aerial vehicle including a feeling-effect showing device is provided. The feeling-effect showing device is adapted for showing a feeling effect such as a visual effect and/or an audio effect. In addition, a method of using a plurality of unmanned aerial vehicles to show a feeling effect is also provided.

### CROSS REFERENCE TO RELATED APPLICATIONS

This application is based on and claims the benefit of priority from the Taiwanese Patent Application No. 106102073 filed on Jan. 20, 2017, which are incorporated herein by reference.

### FIELD OF THE INVENTION

The present invention is related to an aerial vehicle and in particular to an unmanned aerial vehicle and a method of using a plurality of unmanned aerial vehicles.

### DESCRIPTION OF THE PRIOR ART

From the very beginning, unmanned aerial vehicles are used to serve military purposes, for example, long-range surveillance reconnaissance. Recent years see rapid development of civil unmanned aerial vehicles mainly for use in geosurveillance, disaster prevention, disaster relief, commercial aerial photography, and the like. Civil unmanned aerial vehicles are usually operated with a portable remote control from a distance. Therefore, compared with conventional aircraft physically navigated by pilots, civil unmanned aerial vehicles have advantages: high mobility and low operating costs. Furthermore, unmanned aerial vehicles carry no passengers and thus have a low chance of causing casualties in case of accidents; hence, unmanned aerial vehicles are safer than the conventional aircraft.

Therefore, efficient use of unmanned aerial vehicles has room for improvement.

### SUMMARY OF THE INVENTION

The present invention hereby provides an unmanned aerial vehicle for use in an outdoor or indoor place to show a feeling effect (for example, a visual effect, an audio effect and/or a tactile effect).

The present invention hereby also provides a method of using a plurality of unmanned aerial vehicles such that the unmanned aerial vehicles can show a feeling effect in an outdoor or indoor place.

The present invention provides an unmanned aerial vehicle comprising a feeling-effect showing device, adapted for showing a feeling effect.

In an embodiment of the present invention, the feeling-effect showing device comprises a display device, adapted for producing a visual effect included by the feeling effect.

In an embodiment of the present invention, the display device comprises a plurality of display lamps. Each of the display lamps is adapted for displaying at least one colored light. The visual effect is shown according to at least one of displaying states of the display lamps.

In an embodiment of the present invention, the display device comprises a display panel adapted for displaying an image and the visual effect is shown according to the image displayed on the display panel.

In an embodiment of the present invention, the unmanned aerial vehicle further comprises a wireless positioning component, adapted for being sensed by an external positioning system.

In an embodiment of the present invention, the unmanned aerial vehicle further comprises a collision avoidance sensing component.

In an embodiment of the present invention, the feeling-effect showing device comprises a loudspeaker, adapted for producing an audio effect included by the feeling effect.

In an embodiment of the present invention, the feeling-effect showing device comprises a sprayer, adapted for producing a visual effect and/or a tactile effect included by the feeling effect.

The present invention further provides a method of using a plurality of unmanned aerial vehicles to show a feeling effect. The method comprises following steps. First, the unmanned aerial vehicles are arranged within a three-dimensional space, wherein each of the unmanned aerial vehicles comprises a feeling-effect showing device. Afterwards, at least one of the feeling-effect showing devices of the unmanned aerial vehicles is activated to show a feeling effect.

In an embodiment of the present invention, each of the unmanned aerial vehicles comprises a wireless positioning component and/or a collision avoidance sensing component. The arrangement of the unmanned aerial vehicles is achieved by means of wireless communication between the wireless positioning component of each of the unmanned aerial vehicles and an external positioning system and/or by means of sensing function of the collision avoidance sensing components of the unmanned aerial vehicles.

### BRIEF DESCRIPTION OF THE DRAWINGS

FIG. 1 is a schematically perspective view of an unmanned aerial vehicle according to the first embodiment of the present invention.

FIG. 2 is a schematic view of arrangement of a plurality of unmanned aerial vehicles of FIG. 1.

FIG. 3 is a schematically perspective view of an unmanned aerial vehicle according to the second embodiment of the present invention.

### DETAILED DESCRIPTION OF THE EMBODIMENTS

### First Embodiment

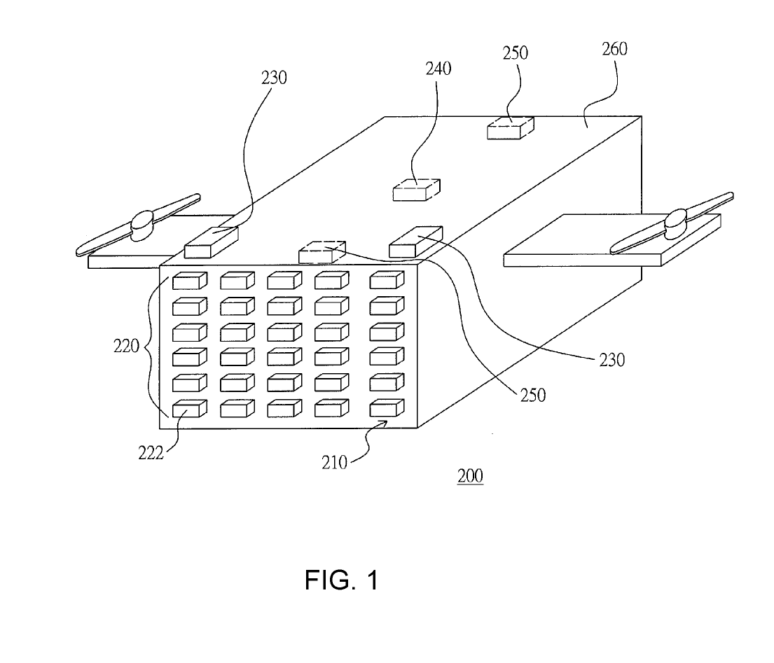

FIG. 1 is a schematically perspective view of an unmanned aerial vehicle according to the first embodiment of the present invention. Referring to FIG. 1, an unmanned aerial vehicle 200 including but not limited to a drone in the first embodiment of the present invention comprises a show surface 210, a display device 220, at least one loudspeaker 230 and a sprayer (not shown). The display device 220 is disposed on the show surface 210 and adapted for showing a visual effect (described later). The sprayer is adapted for showing another visual effect (described later). In this embodiment, the display device 220 comprises a plurality of display lamps 222 which can be disposed in an array on the show surface 210. Each of the display lamps 222 is adapted for displaying at least one colored light. Each of the display lamps 222 can be an LED lamp. In this embodiment, for example, each display lamp 222 provided in the form of an LED lamp comprises a red LED unit, a green LED unit and a blue LED unit (which are not shown), and thus each display lamp 222 can display different colored light. In this embodiment, for example, brightness of the light displayed by each display lamp 222 provided in the form of an LED lamp can be adjustable. Two loudspeakers 230, for example, are positioned proximate to the show surface 210, spaced apart, and adapted for showing an audio effect (described later). The unmanned aerial vehicle 200 may further comprise a wireless positioning component 240 and a collision avoidance sensing component 250 (FIG. 1 schematically depicts two collision avoidance sensing components 250), which are disposed in a casing 260 of the unmanned aerial vehicle 200.

In another embodiment, an unmanned aerial vehicle has a show surface which can be a curved surface (for example, an arc surface) or has a plurality of show surfaces oriented in different directions such that the display lamps disposed on the arc show surface or the show surfaces oriented in different directions can emit light of different colors or different brightness in different directions. Each display lamp may be altered as needed to have a laser source or a white light source. The latter can be covered by a light-penetrable mask and the light-penetrable masks of the display lamps can be of different colors to allow the display lamps to display light of different colors.

In conclusion, the unmanned aerial vehicle 200 of this embodiment comprises a feeling-effect showing device. The feeling-effect showing device includes but is not limited to the display device 220, two loudspeakers 230 and/or the sprayer. The feeling-effect showing device is adapted for showing a feeling effect and includes but is not limited to a visual effect, an audio effect and/or a tactile effect.

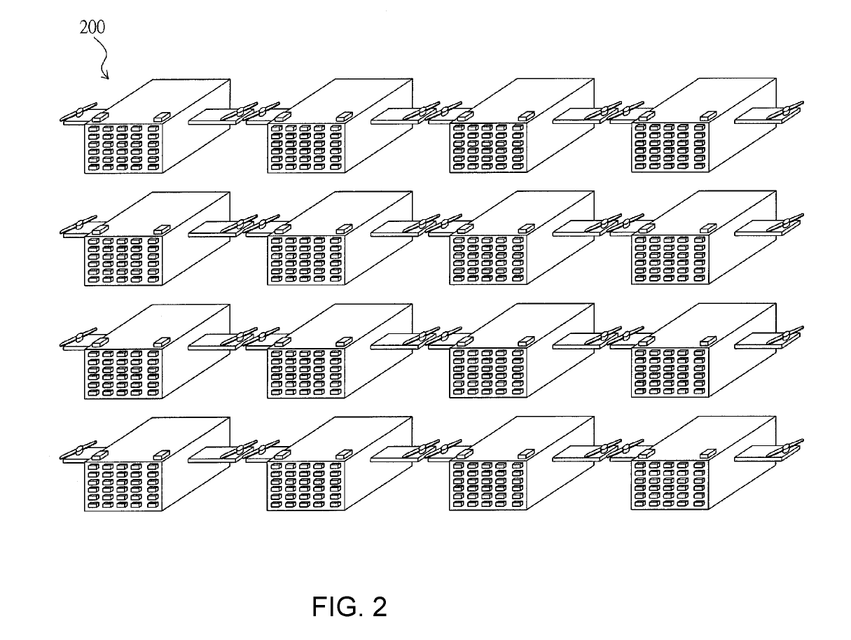

A method of using a plurality of unmanned aerial vehicles 200 to show a feeling effect is described below. FIG. 2 is a schematic view of arrangement of a plurality of unmanned aerial vehicles of FIG. 1. Referring to FIG. 1 and FIG. 2, the unmanned aerial vehicles 200 can be statically arranged within a three-dimensional space of an outdoor venue in order to operate. The static arrangement requires that each of the unmanned aerial vehicles 200 is located at a corresponding and substantially fixed space coordinate at a definite time interval such that the unmanned aerial vehicles 200 are arranged in a substantially fixed pattern. The static arrangement can be decided in advance (for example, configured with a program in advance) or decided at the scene (for example, controlled by a user at the scene). The arrangement of the unmanned aerial vehicles 200 can be achieved by means of the sensing function of the collision avoidance sensing components 250 of the unmanned aerial vehicles 200 (the collision avoidance sensing components 250 are regarded together as a collision avoidance system) and/or wireless communication between an external positioning system (for example, a global positioning system, but is not shown) and the wireless positioning component 240 of each unmanned aerial vehicle 200. The more sensitive the collision avoidance sensing components 250 are, the tighter the unmanned aerial vehicles 200 are arranged.

In another embodiment, the unmanned aerial vehicles 200 can be dynamically arranged within a three-dimensional space of an outdoor venue in order to operate. The dynamic arrangement requires that at least one of the unmanned aerial vehicles 200 flies at an increasing or constant speed to change its position with time. Therefore, in general, the unmanned aerial vehicles 200 are dynamically arranged. The dynamic arrangement is decided in advance or decided at the scene.

In yet another embodiment, the unmanned aerial vehicles 200 can be statically or dynamically arranged within another three-dimensional space in an indoor place. In this yet another embodiment, positioning sensors are respectively disposed at corners in the indoor place in advance to collectively form an indoor positioning system such that the arrangement of the unmanned aerial vehicles 200 is achieved by the sensing function of the collision avoidance sensing components 250 of the unmanned aerial vehicles 200 and/or wireless communication between the indoor positioning system and the wireless positioning component 240 of each unmanned aerial vehicle 200.

In this embodiment, after the unmanned aerial vehicles 200 have been statically arranged, at least one of the display lamps 222 of the display devices 220 of the unmanned aerial vehicles 200 can be activated in an activating way. The activating way may be a specific way of alternating brightness with darkness at different points in time and/or a way of presenting light of a specific color. The activating way is decided in advance or decided at the scene. Therefore, the display lamps 222 of the display devices 220 of the unmanned aerial vehicles 200 collectively show a large image. For instance, when an evening party begins, the display lamps 222 of the unmanned aerial vehicles 200 collectively show a logo of the evening party.

As the evening party goes on, the display lamps 222 of the unmanned aerial vehicles 200 may vary with time to display different patterns. For instance, the display lamps 222 of the unmanned aerial vehicles 200 collectively display the titles of events (for example, a singing competition, riddles & rewards, lucky draws, and the like) held in different stages or different lighting effects at the evening party, as the party goes on. In conclusion, the display devices 220 of the unmanned aerial vehicles 200 can serve the purpose of showing a visual effect. In this embodiment, the visual effect presented by the unmanned aerial vehicles 200 is shown by at least one of displaying states of the display lamps 222 of the display devices 220. If each of the display lamps 222 of the unmanned aerial vehicles 200 is a laser source, the display lamps 222 can show a visual effect such as holography, virtual reality, augmented reality and/or mixed reality.

As the party goes on, at least one of the loudspeakers 230 of the unmanned aerial vehicles 200 can be activated in another activating way. For example, the other activating way may be a way of playing specific music or sound at different points in time. The other activating way is decided in advance or decided at the scene. Therefore, the loudspeakers 230 of the unmanned aerial vehicles 200 collectively show an integrated sound. For instance, the loudspeakers 230 of the unmanned aerial vehicles 200 play a preconfigured soundtrack or theme music at definite time intervals simultaneously or non-simultaneously to render the evening party bustling. The loudspeakers 230 of the unmanned aerial vehicles 200 are designed to be rotatable. In conclusion, the loudspeakers 230 of the unmanned aerial vehicles 200 can serve the purpose of showing an audio effect. In this embodiment, the audio effect presented by the unmanned aerial vehicles 200 is shown by at least one of sounding states of the loudspeakers 230. However, the loudspeakers 230 of the unmanned aerial vehicles 200 can be dispensed with as needed to reduce the weight of the unmanned aerial vehicles 200. In this embodiment, at least one of the sprayers (not shown) of the unmanned aerial vehicles 200 can be activated by yet another activating way (for example, spraying aerosols varying in intensity and/or in different directions at different points in time) to show another visual effect or a tactile effect. This yet another activating way is decided in advance or decided at the scene. However, the sprayers of the unmanned aerial vehicles 200 can be dispensed with as needed to reduce the weight of the unmanned aerial vehicles 200. Alternatively, the display devices 220, rather than the loudspeakers 230 or sprayers, can be dispensed with as needed.

In still yet another embodiment, the unmanned aerial vehicles 200 can be statically arranged in the same way as a symphony orchestra. Each of the loudspeakers 230 of the unmanned aerial vehicles 200 can generate sound of a specific musical instrument (that is, recorded music played with the specific musical instrument or music played with the specific musical instrument by a live band) such that the unmanned aerial vehicles 200 together play music like a symphony orchestra.

In addition to the evening party, the unmanned aerial vehicles 200 can be applicable to any daytime or nighttime activities held outdoors or indoors, such as theme parks, amusement parks, arts festivals, fashion festivals, school fairs, and new year countdown parties (for example, the unmanned aerial vehicles 200 can simulate sound and light effects of fireworks and thus are environment-friendly), opera houses, shopping malls and department stores. In addition, the unmanned aerial vehicles 200 can be applicable to airborne commercial advertisements and other messaging for commercial purposes. Further, the unmanned aerial vehicles 200 can be applicable to government communication signs indicating for instance traffic circumstances on freeways and roadways. The above applications are only examples and not to limit applications of the present invention. Practical application of the unmanned aerial vehicles 200 can be expanded by teaching and research activities to increase diversity of arrangement of the unmanned aerial vehicles 200 and/or enhance the feeling effect shown by the unmanned aerial vehicles 200 together.

In conclusion, in this embodiment, the feeling-effect showing device of the unmanned aerial vehicle 200 is adapted for showing a feeling effect, for example, a visual effect and/or an audio effect and/or a tactile effect. Therefore, owing to the arrangement and presentation of the unmanned aerial vehicles 200, person(s) organizing outdoor or indoor activities can dispense with budgets and working hours otherwise required to prepare for, produce, and mount in place large billboards and banners and/or budgets and working hours otherwise required to prepare for and mount in place a hi-fi. The unmanned aerial vehicles 200 can be used repeatedly and flexibly so as to be variably arranged and shown, thereby meeting the need for different outdoor or indoor activity venues. The unmanned aerial vehicles 200 are arranged and presented to produce diverse, different feeling effects; hence, different outdoor or indoor activities become more artistic and amusing qualitatively and quantitatively.

### Second Embodiment

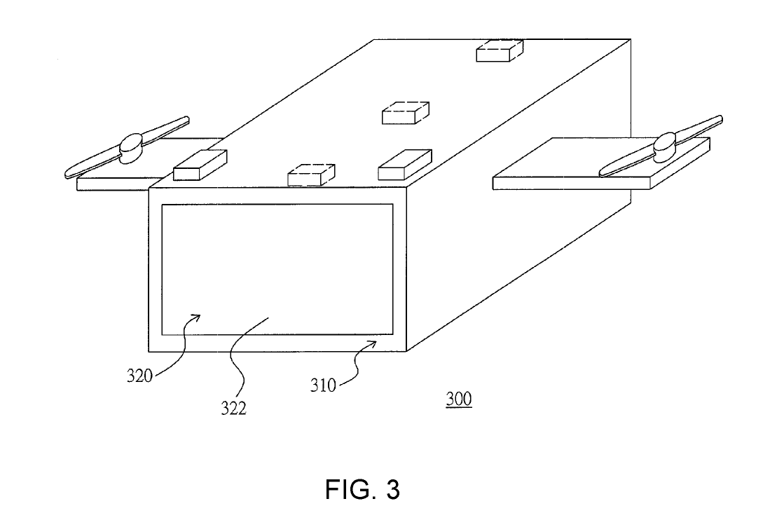

FIG. 3 is a schematically perspective view of an unmanned aerial vehicle according to the second embodiment of the present invention. Referring to FIG. 3 and FIG. 1, the unmanned aerial vehicle 300 of this embodiment is distinguished from the unmanned aerial vehicle 200 of the first embodiment by features described below. The display device 320 of the unmanned aerial vehicle 300 comprises a display panel 322 (for example, a liquid crystal display panel or OLED display panel) to substitute for a plurality of display lamps 222 of the display device 220 of the unmanned aerial vehicle 200. The display panel 322 of the unmanned aerial vehicle 300 is disposed on a show surface 310 and adapted for displaying an image (not shown). In this embodiment, a visual effect of the unmanned aerial vehicle 300 is shown by at least one of the images displayed on the display panel 322.

Based on the above mentioned, the unmanned aerial vehicle and the method of using a plurality of unmanned aerial vehicles to show a feeling effect of an embodiment of the present invention have one of following advantages and another advantage. In this embodiment of the present invention, the feeling-effect showing device of the unmanned aerial vehicle is adapted for showing a feeling effect, for example, a visual effect and/or an audio effect and/or a tactile effect. Therefore, owing to the arrangement and presentation of the unmanned aerial vehicles, person(s) organizing outdoor or indoor activities can dispense with budgets and working hours otherwise required to prepare for, produce, and mount in place large billboards and banners and/or budgets and working hours otherwise required to prepare for and mount in place a hi-fi. The unmanned aerial vehicles can be used repeatedly and flexibly so as to be variably arranged and shown, thereby meeting the need for different outdoor or indoor activity venues. The unmanned aerial vehicles are arranged and presented to produce diverse, different feeling effects; hence, different outdoor or indoor activities become more artistic and amusing qualitatively and quantitatively.

1. A method of using a plurality of unmanned aerial vehicles to show a feeling effect, comprising:
arranging the unmanned aerial vehicles within a three-dimensional space, wherein each of the unmanned aerial vehicles comprises a feeling-effect showing device; and
activating at least one of the feeling-effect showing devices of the unmanned aerial vehicles to show a feeling effect.

2. The method of using a plurality of unmanned aerial vehicles to show a feeling effect of claim 1, wherein each of the unmanned aerial vehicles comprises a wireless positioning component and/or a collision avoidance sensing component, the arranging the unmanned aerial vehicles is achieved by means of wireless communication between the wireless positioning component of each of the unmanned aerial vehicles and an external positioning system and/or by means of sensing function of the collision avoidance sensing components of the unmanned aerial vehicles.

3. An unmanned aerial vehicle, comprising:
a feeling-effect showing device, adapted for showing a feeling effect.

4. The unmanned aerial vehicle of claim 3, wherein the feeling-effect showing device comprises a display device, adapted for producing a visual effect included by the feeling effect.

5. The unmanned aerial vehicle of claim 4, wherein the display device comprises a plurality of display lamps, each of the display lamps is adapted for displaying at least one colored light, and the visual effect is shown according to at least one of displaying states of the display lamps.

6. The unmanned aerial vehicle of claim 4, wherein the display device comprises a display panel adapted for displaying an image and the visual effect is shown according to the image displayed on the display panel.

7. The unmanned aerial vehicle of claim 3, further comprising a wireless positioning component, adapted for being sensed by an external positioning system.

8. The unmanned aerial vehicle of claim 3, further comprising a collision avoidance sensing component.

9. The unmanned aerial vehicle of claim 3, wherein the feeling-effect showing device comprises a loudspeaker, adapted for producing an audio effect included by the feeling effect.

10. The unmanned aerial vehicle of claim 3, wherein the feeling-effect showing device comprises a sprayer, adapted for producing a visual effect and/or a tactile effect included by the feeling effect.
